(19) United States
(12) Patent Application Publication
(10) Pub. No.: US 2008/0314072 A1
(43) Pub. Date: Dec. 25, 2008

(54) Air-Conditioning Unit for Mobile Devices

(75) Inventors: Johann Plank, Eggstatt (DE); Thomas Schutz, Pahl (DE)

Correspondence Address: D. PETER HOCHBERG CO. L.P.A., 1940 EAST 6TH STREET, CLEVELAND, OH, 44114, US

(73) Assignee: Truma Geratetechnik GmbH & Co. KG, Putzbrunn (DE)

(21) Appl. No.: 12/083,399

(22) PCT Filed: Oct. 14, 2005
(86) PCT No.: PCT/EP2005/011107

§ 371 Date: May 9, 2008

(51) Int. Cl. F25B 1/00; F25D 17/06; B60H 1/32

(52) U.S. Cl. 62/498; 62/426; 62/239

(57) ABSTRACT

An air-conditioning device includes a refrigeration cycle having components such as, e.g., a compressor for compressing a refrigerant, a condenser and an evaporator. At least some of the components of the refrigeration cycle are held in their functional position by a mounting in the form of housing shells, which they share. The housing shells consists of a foamed plastic material, e.g. of expanded polypropylene (EPP). An additional metal sheet or plastic housing is not required.

### CROSS-REFERENCE TO RELATED APPLICATION

This application is a National Stage application of International Application No. PCT/EP2005/011107, filed on Oct. 14, 2005.

### BACKGROUND OF THE INVENTION

1. Field of the Invention

According to the preamble of patent claim 1, the invention relates to an air-conditioning device for refrigerating a room.

An air-conditioning device and/or an air-conditioning facility of this type is suitable also, in particular, for cooling interior spaces of caravans, boats or other, in particular mobile, small spaces. The principle of cold generation by means of a refrigerant cycle, on which the cooling of air is based, has been known for a long time.

2. Description of the Prior Art

DE 198 02 055 A1 specifies a housing for an air-conditioning facility of a motor vehicle that consists of two parts that are made of a plastic particle foam. The two parts are being held together by a connection element by means of a non-positive connection.

FIG. 9 shows the functional diagram of a refrigerant cycle and/or cryo-process that is known, e.g., from DE 201 11 475 U1 and is applied in numerous air-conditioning facilities.

A compressor 1 compresses a gaseous refrigerant and transports it via a refrigerant line 2 to a condenser 3. The condenser 3 serving as heat exchanger is being cooled by ambient air that is being aspirated by means of a condenser fan 4 via an ambient air intake 5 and is being expelled via an ambient air outlet 6. This causes the refrigerant, which is initially gaseous and under a high-pressure, to liquefy (condense). The liquid refrigerant, which is still under a high-pressure, is then guided via a refrigerant line 7 to an expansion facility, e.g. a regulating valve 8, where the refrigerant can expand.

Due to the expansion, the refrigerant transitions into the gas phase and removes heat from its surroundings in the process. This removal of heat acts via an evaporator 9 serving as heat exchanger on the room air of the room to be refrigerated, which is being aspirated through a room air intake 11 by means of an evaporator fan 10, and then guided through the evaporator 9, and expelled as cold air back into the room to be refrigerated via one or more room air outlets 12. The room air can be cleaned by a filter 13 upstream of the evaporator 9 during this process.

By taking up the heat of the room air to be cooled, the gaseous refrigerant is heated up and conveyed back to the compressor 1 via a refrigerant line 14. Inside the compressor 1, the refrigerant, which is gaseous again at this time, is compressed again and the refrigerant cycle is continued as described above.

It is common to accommodate the components of an air-conditioning device of this type in a housing box such as is also shown in DE 201 11 475 U1. The housing box can have walls made of sheet metal or of a suitably stable plastic material.

An air-conditioning device of this type has proven to be very useful in practical application. However, it has become evident that it can still be improved, in particular with regard to reducing its weight and costs.

### SUMMARY OF THE INVENTION

The invention is therefore based on the object to devise an air-conditioning device that has a lower weight and can be manufactured at a lower costs, while maintaining the functions described above.

The object is met according to the invention by an air-conditioning device having the features of patent claim 1. Advantageous further developments of the invention are defined in the dependent claims.

An air-conditioning device according to the invention is characterized in that at least some of the components of the refrigeration cycle are held in their functional position by a mounting they share, whereby the mounting consists of a foamed plastic material. The term, components, shall be understood to essentially mean the components of the refrigerant cycle described above referring to FIG. 9, whereby refrigerant lines or electrical connections can also be taken into consideration.

The foamed plastic material—in particular, if this concerns expanding and/or expanded polypropylene, EPP—has excellent stability properties allowing it to hold the components reliably. Moreover, it is a comparatively cheap material and easy to process—presuming that the shapes are suitable. At suitable large-scale manufacture, which results foremost in serial production, the mounting can be manufactured at very low cost by foaming, pressing or/and milling. Moreover, the foamed plastic material has excellent heat insulation properties which is advantageous considering the temperature differences that occur in and on the air-conditioning device. Due to it being a foam, the plastic material also possesses an excellent noise-reducing effect such that the noise from the compressor, the fans, and the air stream on the inside of the air-conditioning device can reach the outside only after being absorbed.

It is particularly advantageous for the mounting to be formed by at least two mutually interacting shells. It is then feasible to arrange the components of the refrigerant cycle between the shells and fix them in the desired functional position by means of the shells.

In this context, it can be advantageous for the shells to be held together by straps. The straps allow to dispense with having to have additional connection means between the shells.

However, it can be useful according to a further development of the invention for each of the shells to have a latching facility each in its respective marginal area which borders on the marginal area of another shell, such that the two shells can be latched together. By this means, a, e.g., form-fitting connection can be established between the shells forming the mounting, which might render further attachment means superfluous. It is self-evident that the shells can, in addition, be held together also by further means, e.g. the straps described above, attachment screws or attachment pegs.

In a preferred embodiment of the invention, the latching facility has a tongue and/or groove that is made from the foamed plastic material such that it forms a single part with the corresponding shell. If the shells each are equipped with tongues or grooves, it is feasible very easily to latch the shells to each other by pressing them together. A similar principle is known, e.g. in the case of ice boxes, whose opening can be closed by a latching lid. It is self-evident though, that the latching facilities connecting the shells to each other should be provided to be more robust in order to ensure that the connection is reliable.

It is particularly advantageous for the mounting, in particular the interacting shells, to have recesses and/or guidance means, in which the components are held in an essentially form-fitting fashion. The individual components of the refrigeration cycle can then simply be inserted in the recesses or latched in, if applicable, during the assembly of the air-conditioning device. By joining the shells, the components become reliably fixed in their respective position such that they cannot slip from their recesses even if the entire device is dropped. Likewise, recesses and/or receptacles or guidance means can also be provided in the foam material of the mounting for connection lines, e.g. for conveying the refrigerant.

Owing to the elastic properties of the plastic material, it is feasible to also hold the components in the recesses in a spring-like fashion, in addition to the basically form-fitting fixation. It will not be possible to completely exclude that the plastic material will have an elastic effect, such that this effect can be utilized instead in order to latch or clamp the components in the mounting in a spring-like fashion.

It is particularly advantageous for the mounting to simultaneously form a housing of the air-conditioning device such that the shells also assume the function of housing shells. In this case, it is feasible to dispense with having an additional housing, in particular with having a conventional sheet metal or plastic housing. The mounting made of the foamed plastic material then simultaneously forms a complete, functional housing which renders the costly and weight-adding provision of a separate housing superfluous. Rather, the air-conditioning device having the mounting as its external skin can be fitted as a unit in a mobile facility, e.g. a mobile home or caravan.

The multifarious design options available for the formed shells allow for further simplification by integration of functions. Accordingly, it is feasible in a particularly advantageous embodiment of the invention, that at least a part of an internal side of a shell forms a part of an air guidance channel for the ambient air or the room air. Essential parts of the air guidance channels on the inside of the air-conditioning device can therefore be formed by the shells themselves.

Moreover, a drive driving the condenser fan and/or the evaporator fan can be held in the mounting. In order to limit the costs, it can be interesting in this context to have the condenser fan and the evaporator fan be driven by a drive they share.

Preferably, one of the shells is a bottom shell at the underside of which openings for take-in and expelling of the ambient air are provided. This is facilitated by the design described in DE 201 11 475 U1, in which the ambient air after being heated up by the air-conditioning device can be expelled downwards, through the floor of a mobile home, in order to dissipate the heat.

It is also feasible to provide in the bottom shell a condensate pan, in which moisture that condenses in particular on the evaporator can be collected.

Designing an air-conditioning device according to the invention affords significant advantages: substantial costs can be saved by dispensing with having a classical housing. The cost advantage is improved even further in that packaging material can be saved during the manufacture, which packaging material usually is needed since the air-conditioning device is not fitted directly in its final location by the manufacturer of the air-conditioning device, but rather needs to be packaged extensively and transported to a customer, who then proceeds with the fitting. In the air-conditioning device according to the invention, the mounting represents both the housing and the packaging simultaneously.

Furthermore, substantial weight can be saved. Having optimized, in particular smoothened and rounded airways, the flow noise is reduced. Noise that is generated on the inside of the air-conditioning device regardless, is attenuated by the shells that close as completely as possible. The simple insertion of the components and their form-fitting reception in the mounting allow the efforts involved in assembly to be clearly reduced. Manufacturing variations that may possibly occur during the manufacture of the mounting are non-problematic, since the elasticity of the foamed plastic material allows for generous compensation thereof.

These and other advantages and features of the invention are illustrated in more detail in the following based on the accompanying figures.

### BRIEF DESCRIPTION OF THE DRAWINGS

FIG. 1 shows a perspective view of an air-conditioning device according to the invention in an open state;

FIG. 2 shows a perspective view of the air-conditioning device of FIG. 1 from a different direction;

FIG. 3 shows a perspective view of the air-conditioning device of FIG. 1 in a closed, assembled state;

FIG. 4 shows a perspective view of a second embodiment of the air-conditioning device according to the invention;

FIG. 5 shows a bottom view of the air-conditioning device of FIG. 4;

FIG. 6 shows a perspective view of an opened air-conditioning device in a third embodiment of the invention;

FIG. 7 shows a perspective view of a bottom shell of the air-conditioning device of FIG. 6;

FIG. 8 shows a perspective view of the inside of a top shell of the air-conditioning device of FIG. 6; and

FIG. 9 shows a functional diagram of a known refrigeration cycle.

### DETAILED DESCRIPTION OF THE PREFERRED EMBODIMENTS

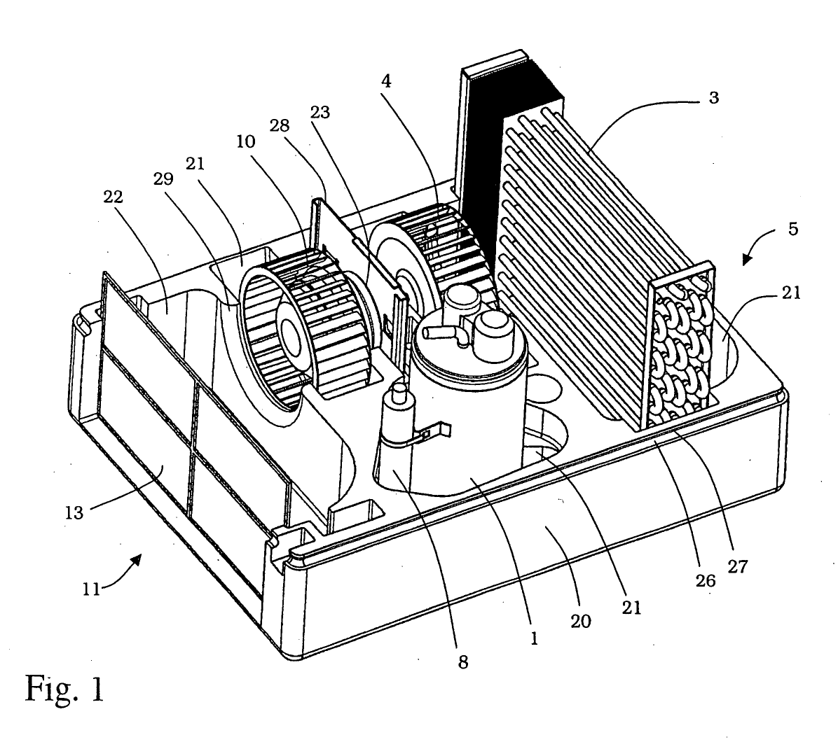

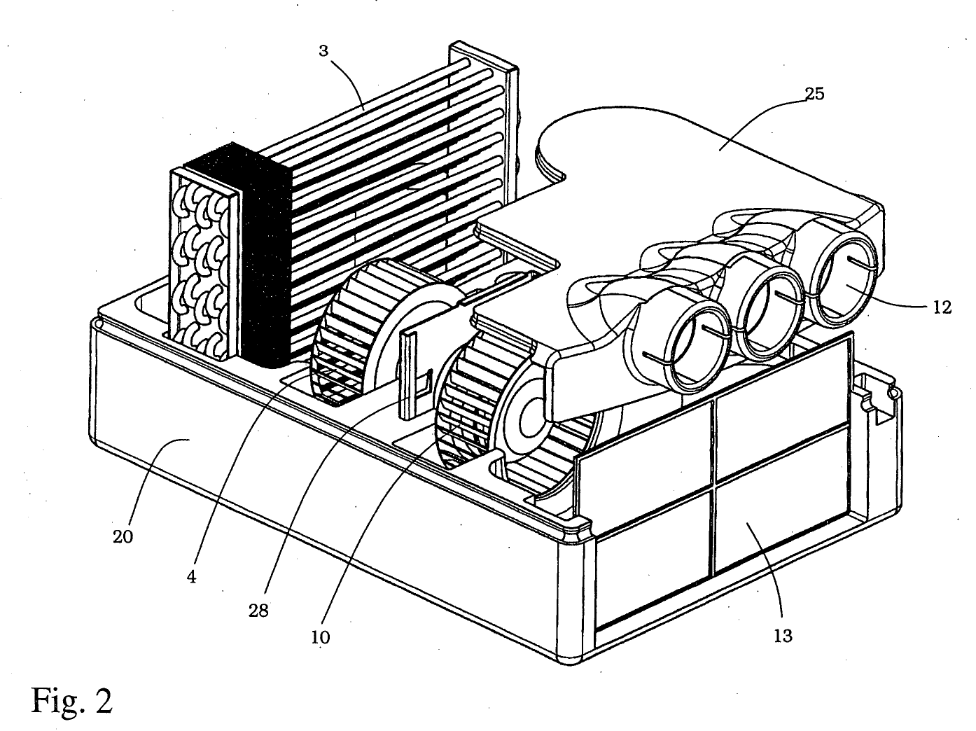

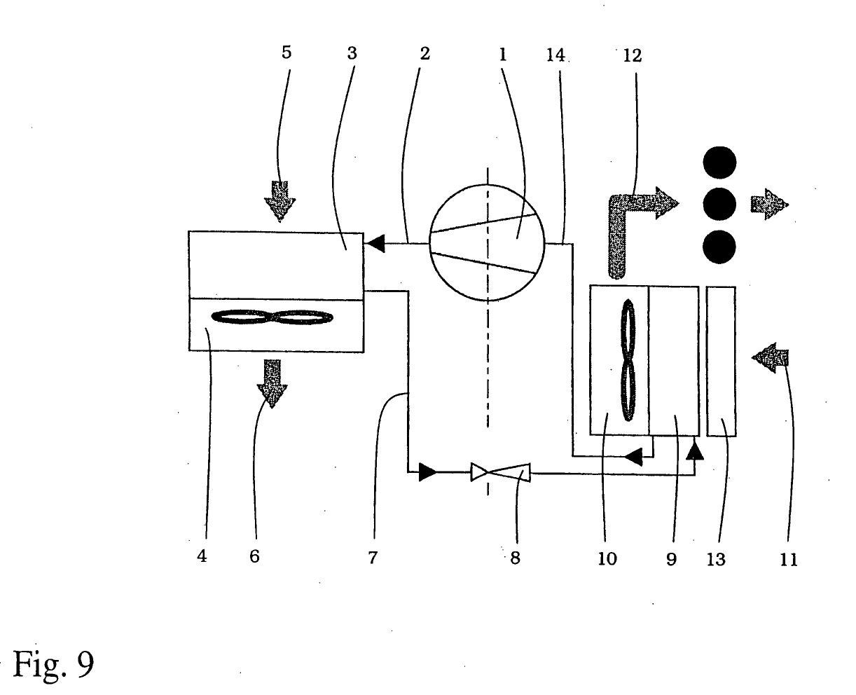

FIGS. 1 to 3 show perspective views of a first embodiment of the invention in various states of assembly. Since a refrigeration cycle has already been illustrated above with reference being made to FIG. 9, the same reference numbers as in FIG. 9 are used for reasons of simplification.

Essential components of the refrigeration cycle are plugged into multiple recesses 21 and/or indentations or guidance means in a bottom shell 20 that forms a part of a mounting according to the invention.

The components of the refrigeration cycle include, in particular, a compressor 1 serving for compressing the refrigerant, a heat exchanger serving as condenser 3, a condenser fan 4, an evaporator fan 10, and a regulating valve 8. A heat exchanger that is required for the air-conditioning device to function and serves as evaporator (corresponding to reference number 9 in FIG. 9) is not shown in FIGS. 1 to 3. It is to be placed into an evaporator recess 22. A filter 13 for cleaning of the room air aspirated via a room air intake 11 can be arranged upstream of the evaporator.

With regard to the generally known mode of function of the air-conditioning device, reference shall thus be made to the description above related to FIG. 9.

The two ventilator wheels of the condenser fan 4 and the evaporator fan 10 are driven by a drive 23 they share.

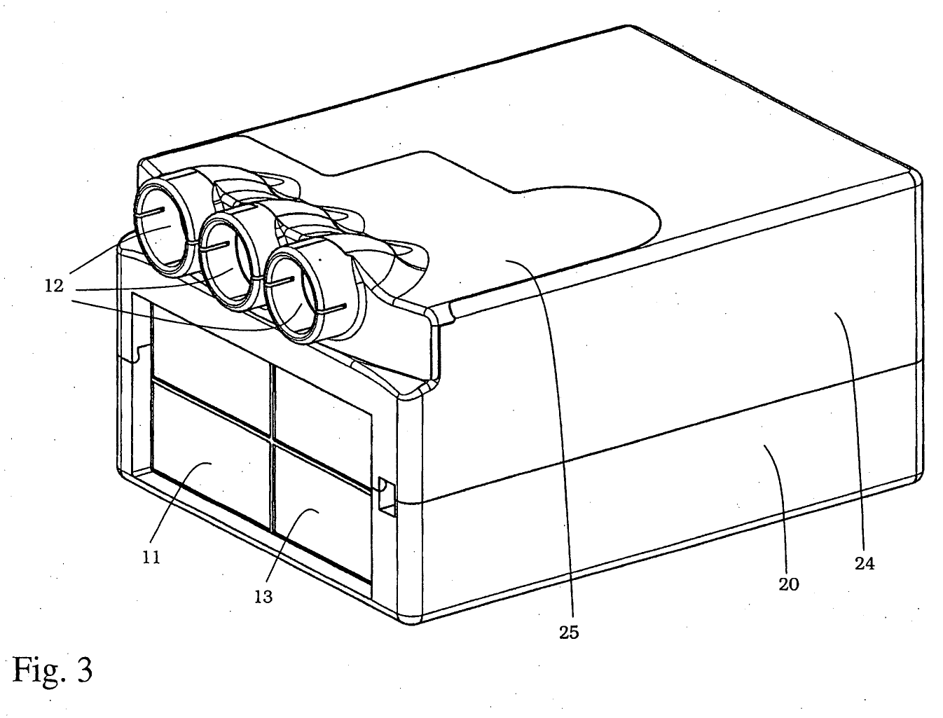

As shown in FIG. 3, a top shell 24, into which another shell element is inserted that serves as connection shell 25, is positioned on the bottom shell 20. The shells 20, 24, 25 are made of a foamed plastic material, preferably of expanded polypropylene, EPP. However, other foamed plastic materials may be used just as well, provided they ensure the required stability, meet the imperviousness requirement (for water and air), and have the required accuracy of fit.

The shell elements 20, 24, and 25 are fitted into each other in such a fashion as to jointly form a closed housing box, as shown in FIG. 3. By this means, the air-conditioning device does not need to be placed in a housing box made of sheet metal or of sheet metal-like plastic walls in conventional fashion. The shells 20, 24, and 25 fully assume the function of housing, whereby the connection shell 25 does not necessarily have to serve as mounting.

Moreover, the bottom shell 20 and the top shell 24, in particular, serve as mounting for the components of the refrigeration cycle. As has been shown above based on FIG. 1, the individual components are plugged into the respective recesses 21, 22 of the bottom shell 20. The top shell 24 has corresponding matching recesses such that the top shell 24 can be placed onto the bottom shell 20 and the components each are held in their final functional position thereby.

In order to attain a reliable connection at least between the bottom shell 20 and the top shell 24, latching facilities are provided in each of these in the form of grooves 26 and the tongues 27 on the edge of the shells 20, 24. The grooves 26 and tongues 27 are shaped such that a tongue 27 of one shell engages in the groove 26 of the other shell. Since the foam material is elastic, the tongues 27 move into the corresponding grooves 26 in a spring-like fashion such that the bottom shell 20 ultimately is connected to the top shell 24 in a form-fitting fashion. If required, this state can be secured by further securing elements, as is illustrated below.

The connection shell 25 that is inserted in the top shell 24 has three openings that are shown in FIG. 3 and serve as room air outlet 12, through which the air refrigerated by the evaporator 9 can be discharged by the evaporator fan 10 into the room to be refrigerated. For example tube-shaped cold air lines can also be connected to the room air outlets 12.

An ambient air intake 5 (not shown in FIGS. 1 to 3) is provided in the bottom shell 20 upstream of the condenser 3 such that ambient air needed for heat dissipation can be aspirated via the bottom of the bottom shell 20 by the condenser fan 4 and can be guided through the condenser 3. The ambient air that has been heated by the condenser 3 can then be discharged downwards via an ambient air outlet 6 that is also not shown in the figures and is provided below the ventilator wheel of the condenser fan 4.

The drive motor 23 for the two fans 4, 10 is attached to one support wall 28 that is also being held between the bottom shell 20 and the top shell 24.

A wall of the bottom shell 20 between the evaporator recess 22 and the ventilator wheel of the evaporator fan 10 is designed in the form of an intake nozzle 29 in order to adversely affect the stream of the passage of air as little as possible.

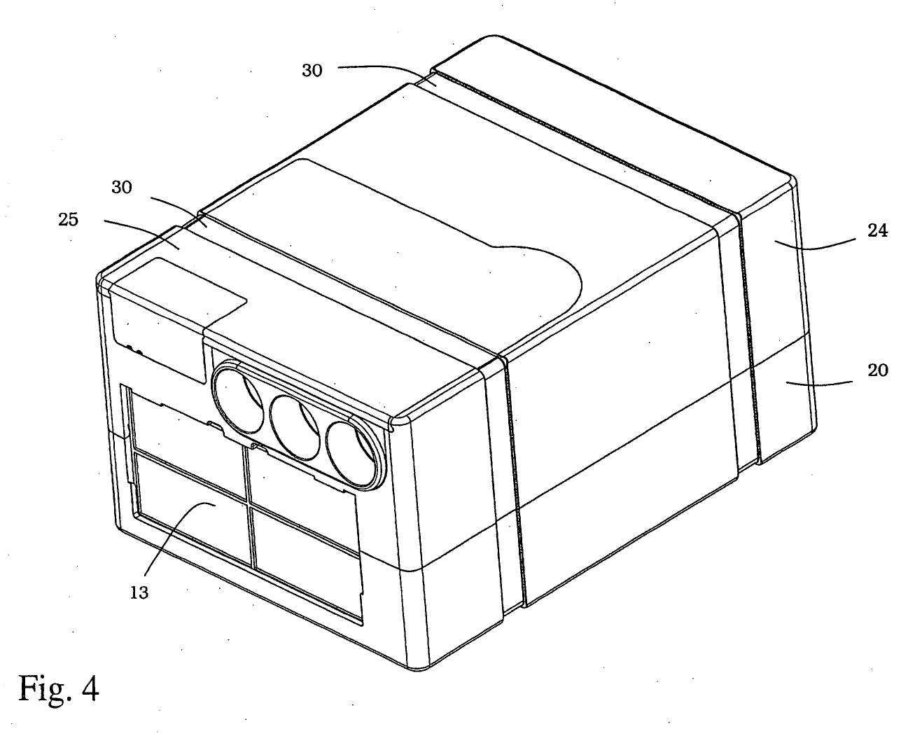

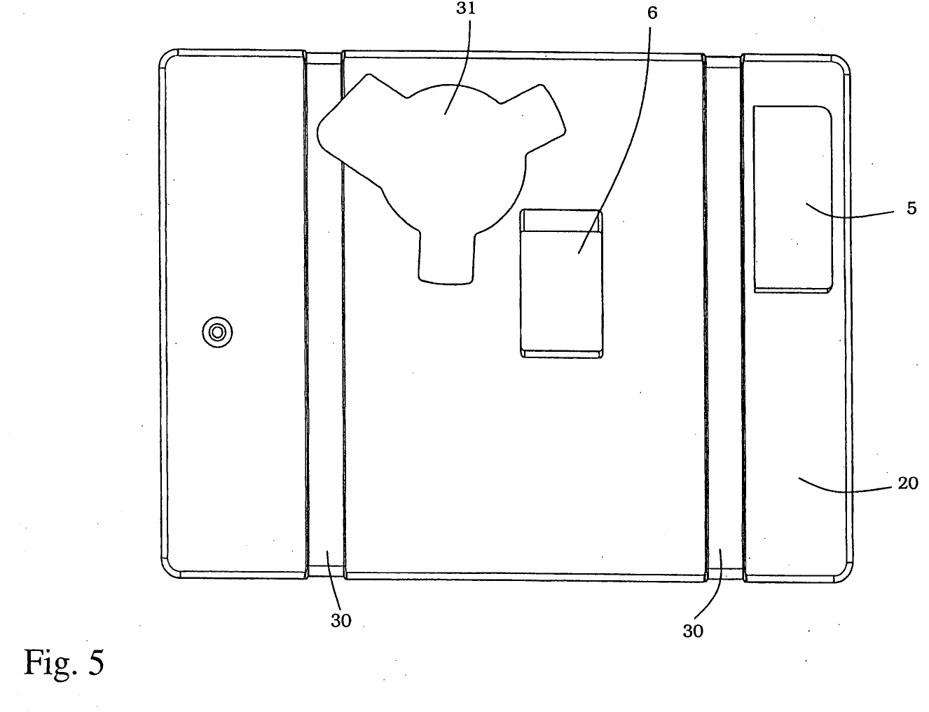

FIGS. 4 and 5 show a perspective view and a bottom view, respectively, of a second embodiment of the invention. For simplification, the same reference numbers are used as in FIGS. 1 to 3 and FIG. 9, although individual components may differ in design.

In contrast to the embodiment of the air-conditioning device according to the invention shown in FIGS. 1 to 3, the bottom shell 20 and the top shell 24 of the second embodiment are held together by straps (that are not shown) that can be inserted in corresponding strap guidance means 30 that are provided on the outsides of the shells 20, 24. The straps can be plastic or metal straps that should be easy to install and whose length should be adjustable.

Using the straps, is feasible to attach the entire device on a bottom plate of, e.g., a mobile home. Corresponding holding elbows can be provided on the bottom plate.

FIG. 5 shows also the ambient air intake 5 and the ambient air outlet 6 on the underside of the bottom shell 20.

Reference number 31 identifies an optional metal sheet on the underside of the bottom shell 20 that can be screwed to bottom shell 20 from outside for additional fixation of the compressor 1 that is arranged above it. This additional attachment of the compressor 1 may be required, if it were difficult for technical reasons to sufficiently hold the compressor 1 on the inside of the bottom shell through the foamed plastic material.

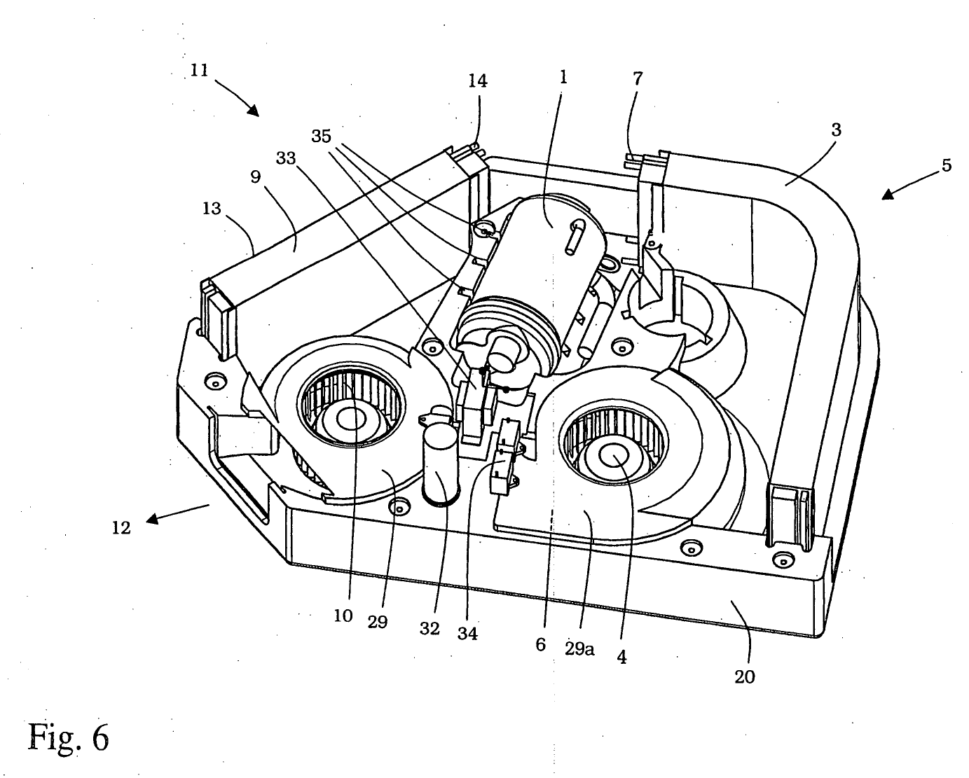

FIGS. 6 to 8 show a third embodiment of the invention, in which the same underlying principle of the invention is used. Only the design and arrangement of the individual complements of the refrigeration cycle have been changed. However, for simplification purposes, the same reference numbers as previously are used herein.

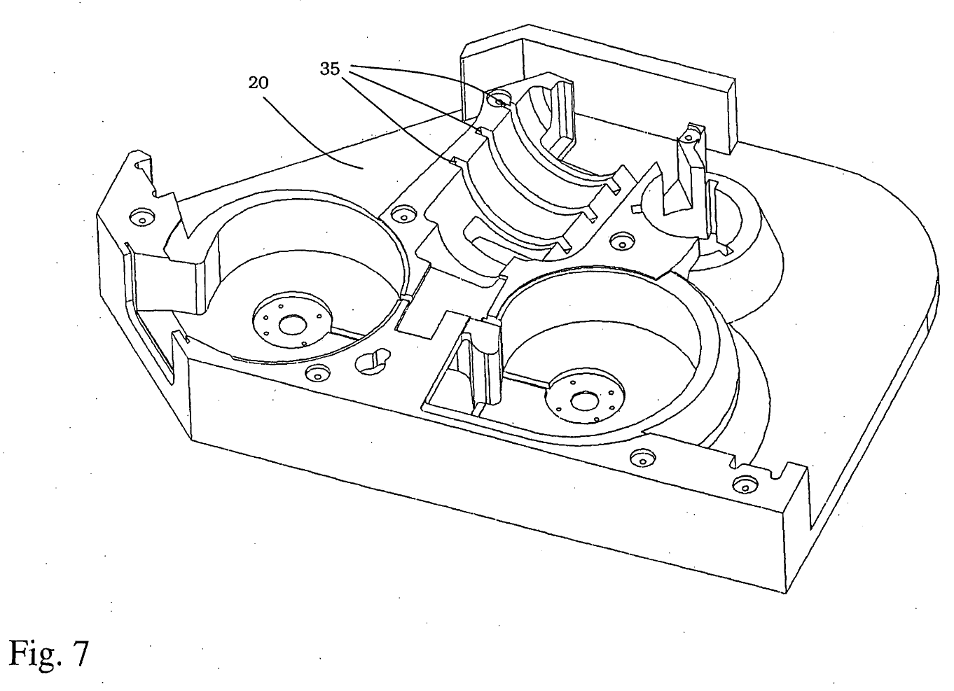

FIG. 7 shows the bottom shell 20 made of expanded polypropylene EPP having the various recesses in which the components can be inserted.

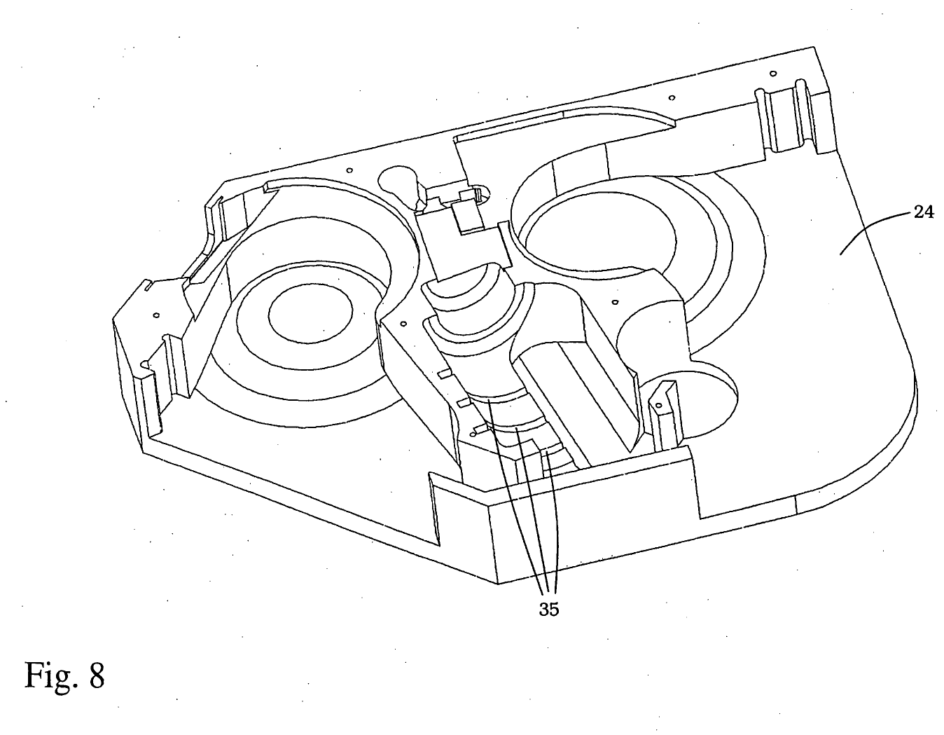

Accordingly, FIG. 8 shows the internal view of the top shell 24 having the corresponding recesses.

The condenser fan 4 and the evaporator fan 10 are inserted into the bottom shell 20 in the form of radial ventilators. Moreover, a compressor 1 is provided.

The condenser 3 is shown schematically only and forms a part of a curved wall of the device. The ambient air can be aspirated via the ambient air intake 5 that faces outwards, guided through the condenser 3, and discharged again downwards via the condenser fan 4 and the ambient air outlet 6.

A heat exchanger is inserted in the form of a schematically-shown evaporator 9 on the evaporator side, which is separated from the condenser side, such that it forms a part of a wall of the air-conditioning device. A filter 13 can be arranged upstream of the evaporator 9. The room air to be refrigerated is aspirated via the room air intake 11 and the filter 13 by the evaporator 9 due to the effect of the evaporator fan 10. It flows via the intake nozzle 29 through the evaporator fan 10 and is discharged as refrigerated air via the room air outlet 12. The intake nozzle 29 can also be manufactured as a milled part or pressed part made of expanded polypropylene. An inflow nozzle 29a that corresponds to the intake nozzle 29 must also be placed on the top side of the condenser fan 4 also.

The air guidance pathways on the inside of the bottom shell 20 and top shell 24 are separated from each other such that no air from the condenser area (right part of FIG. 6) can get to the evaporator area (left part of FIG. 6) and vice versa. Rather, the foamed plastic material provides excellent heat insulation between the different temperature areas inside the air-conditioning device.

Further components, such as, e.g., running capacitors 32 for the compressor 1, an electrical regulating valve 33 for the condenser or electrical capacitors 34 for the fans 4, 10, can be inserted in the shells 20, 24.

FIGS. 6 to 8 shows grooves 35 that are provided in the bottom shell 20 or the top shell 24. Absorption elements can be inserted into the grooves 35 and used for uncoupling from the vibrations of the compressor 1, which is to be arranged at the suitable location, with respect to the shells 20, 24. By this means, the compressor 1 is supported inside the shells 20, 24 in a vibration-absorbing fashion such that the noise generated by the compressor 1 can be reduced. Suitable insulation materials for insertion into the grooves 35 include, e.g., strips, blocks or wedges made of PU or similar materials.

The invention has been described above by means of an air-conditioning device for refrigeration of a room. However, in a particularly advantageous further development of the invention, the air-conditioning device can optionally also be used as a room-heating installation. For this purpose, a suitable valve facility, e.g. a four-way valve, is provided in the air-conditioning device and can be used to reverse the refrigerant cycle. This means that the flow of the refrigerant through the heat exchangers (condenser 3, evaporator 9) can be reversed depending on the position of the valve facility such that the two heat exchangers exchange their function. By this means, it is feasible to remove heat from the surroundings by means of the heat exchanger (now: evaporator 3) through which ambient air flows and pass it to the room air by means of the heat exchanger 9 which now works as condenser.

With the aid of simple components, such as, e.g., the valve facility described above and additional reflux valves, lines, and regulating valves, it is therefore easily feasible to also equip the air-conditioning device, which was originally designed solely as an air-conditioning apparatus, with a heat pump function for heating of the room. The air-conditioning device is then excellently suited for being fitted in mobile homes, caravans, small lodges, and, e.g., boats.

1. Air-conditioning device for refrigeration of a room, said air-conditioning device having a refrigeration cycle comprising:
a compressor for compressing a refrigerant, said refrigerant having a flow pathway;
a condenser having an assigned condenser fan for taking-in and discharging ambient air;
an expansion facility for expanding the refrigerant; and
an evaporator having an assigned evaporator fan for taking-in and discharging room air of the room to be refrigerated; and
a mounting comprising of a foamed plastic material for holding the components of the refrigeration cycle in their function position.

2. Air-conditioning device according to claim 1, wherein the plastic material is expanded polypropylene (EPP).

3. Air-conditioning device according to claim 1, wherein the mounting is formed by at least two shells that interact with each other.

4. Air-conditioning device according to claim 3, wherein the at least two shells are held together by straps.

5. Air-conditioning device according to claim 3, wherein each of the at least two shells has a marginal area and a latching facility in the respective marginal areas bordering on the marginal area of the other of the at least two shells, the latching facilities of the at least two shells cooperating to latch the at least two shells together.

6. Air-conditioning device according to claim 5, wherein the latching facility of one of the at least two shells has a tongue and/or groove that is made from the foamed plastic material such that the tongue and/or groove forms a single part with the corresponding one of another of the at least two shells.

7. Air-conditioning device according to claim 1, wherein the mounting has recesses and/or guidance means for holding the compressor, the condenser, the expansion facility and the evaporator in an essentially form-fitting fashion.

8. Air-conditioning device according to claim 7, wherein the compressor, the condenser, the expansion facility and the evaporator are held in the recesses and/or guidance means of the mounting in a spring-like fashion due to the elastic properties of the plastic material.

9. Air-conditioning device according to claim 1, wherein the mounting forms a housing of the air-conditioning device.

10. Air-conditioning device according to claim 3, wherein the at least two shells are housing shells.

11. Air-conditioning device according to claim 1, wherein the mounting is not surrounded by a further housing.

12. Air-conditioning device according to claim 3, wherein at least a part of an internal side of one of the at least two shells forms a part of an air guidance channel for the ambient air or the room air.

13. Air-conditioning device according to claim 1, wherein said mounting holds a drive, and wherein the condenser fan and the evaporator fan are driven by the drive.

14. Air-conditioning device according to claim 3, wherein one of the at least two shells is a bottom shell located on the underside of the air-conditioning device and having openings for taking-in and discharging ambient air.

15. Air-conditioning device according to claim 3, wherein one of the at least two shells is a bottom shell having a condensate pan.

16. Air-conditioning device according to claim 1, wherein the air-conditioning device is structured to be fitted as a unit in a mobile facility.

17. Air-conditioning device according to claim 1, wherein the flow pathway of the refrigerant can be changed such that the condenser and the evaporator exchange their function and the air-conditioning device works as heat pump for heating the room.

18. Air-conditioning device according to claim 1, wherein the mounting is devoid of a sheet metal housing and a plastic housing.

19. Air-conditioning device according to claim 16, wherein the mobile facility is a mobile home or a caravan.
